(19) United States
(12) Patent Application Publication
(10) Pub. No.: US 2025/0164635 A1
(43) Pub. Date: May 22, 2025

(54) VEHICLE WITH OFFSET EXTEROCEPTIVE SENSOR

(71) Applicant: NAVYA MOBILITY, VILLEURBANNE (FR)

(72) Inventor: Pierre-Emmanuel VIEL, PARIS (FR)

(73) Assignee: NAVYA MOBILITY, VILLEURBANNE (FR)

(21) Appl. No.: 18/840,178

(22) PCT Filed: Feb. 22, 2023
(86) PCT No.: PCT/FR2023/050252

§ 371 Date: Aug. 21, 2024

(30) Foreign Application Priority Data
Feb. 22, 2022 (FR) FR2201586

(51) Int. Cl. G01S 13/931; G01S 13/89; G01S 17/931

(52) U.S. Cl. CPC G01S 13/931; G01S 13/89; G01S 17/931; G01S 2013/93273

(57) ABSTRACT

A vehicle for transporting goods and/or people in a traffic lane intended for right-hand driving or left-hand driving, for a given exteroceptive sensor model, a single sensor of this model is positioned on a front portion of the vehicle in order to obtain information about the environment in which the vehicle is located, referred to as a single front sensor. For right-hand driving the single front sensor is offset to the left and for left-hand driving the front sensor is offset to the right, from a mid-sagittal plane separating a left portion from a right portion of the vehicle.

### TECHNICAL FIELD

The field of the invention is robotics, and more particularly autonomous vehicles and driver assistance systems.

### BACKGROUND

In the field of autonomous vehicles and driver assistance systems, two types of sensors are conventionally used: exteroceptive sensors, which are intended for observing their environment (laser-based remote sensing sensors known as LiDAR, cameras, radars, satellite-based positioning sensors), and proprioceptive sensors, which focus on the internal state.

For a given model of exteroceptive sensors, such as LiDARS, when the choice is made to install two on a vehicle, these are either mounted near the front left and front right corners of the vehicle for the purposes of detecting obstacles and other users of the road, or are placed on the roof at the front and rear on the mid-sagittal plane of the vehicle, i.e. in the middle of its width, for the purposes of localization via SLAM (“Simultaneous Localization And Mapping”) for example.

In the first case, this choice is dictated by the desire to have a redundant solution where the most critical field of view (FOV) remains covered by the other sensor during a loss of one of the two. This placement at or near each front corner is particularly true for scanning LiDARs, which are rotating LiDARs scanning a horizontal angle of up to 360°. When their FOV and their orientation allow them to observe each other, as long as they are not single-layer LiDARs and therefore provide a vertical FOV (VFOV, as opposed to a horizontal FOV or HFOV) not reduced to a spot, this configuration also has the advantage of allowing detection, by the observing sensor, over a certain height range at the observed sensor level.

When these sensors are placed in a low position, their mutual observation compensates for the fact that at the origin of the FOV of the observed sensor the latter suffers from being unable to detect the size of a very close obstacle and therefore is potentially sensitive to dust and rain; mutual observation then makes it possible to evaluate the thickness of the detected obstacle in order to filter out false positives.

When these sensors are at a height close to the roof, this generally indicates that they are also used for localization. But due to the closer proximity between the two sensors than in the second option which sees them generally placed at the front and at the rear, the heading measurement is less precise and the risk of an obstacle simultaneously reducing the FOVs of the two sensors is greater than if they were spaced further apart.

The second case where the two sensors are placed on the roof in the mid-sagittal plane of the vehicle indicates that it is the need for localization which is addressed first, even if they can also be used for obstacle detection beyond the first few meters. This solution, which was preferred for symmetrical vehicles not making a distinction between front and rear, tends however to disappear along with the abandonment of bidirectionality, in favor of a simple central sensor or the two-sensor solution, generally LiDARs, mentioned above.

Note that certain vehicles choose four scanning LiDARs placed at the four corners of the vehicle, thus making it possible, when a LIDAR is lost, for the entire horizontal field that it covered to remain covered by the LiDARs of the two adjacent corners.

Note also that when the exteroceptive sensor, in order to limit costs, is installed alone for localization purposes and/or for the detection of obstacles and other road users, it is systematically placed in the mid-sagittal plane of the vehicle. This position makes the obtained perception symmetrical for the left and right of the vehicle.

### SUMMARY

The invention aims to improve the perception of the environment of a vehicle traveling in a traffic lane when a single sensor of a given exteroceptive sensor model is installed on a front portion of the vehicle.

To this end, the invention relates to a vehicle for transporting goods and/or people in a traffic lane intended for right-hand driving or left-hand driving, comprising, for a first given exteroceptive sensor model, a single sensor of this first model positioned on a front portion of the vehicle in order to obtain information about the environment in which the vehicle is located, referred to as single front sensor. In the case of right-hand driving the single front sensor is offset to the left and in the case of left-hand driving said front sensor is offset to the right, from a mid-sagittal plane separating a left portion from a right portion of the vehicle.

Some preferred but non-limiting aspects of this vehicle are as follows:
it comprises a left side, a right side, and a front side which connects the left side and the right side, the single front sensor being positioned on the front portion of the vehicle at the connection between the left side and front side in the case of right-hand driving or at the connection between the right side and the front side in the case of left-hand driving;
the single front sensor is positioned in an upper part of the front portion of the vehicle;
it comprises a roof which has a left front portion at the connection between the left side and the front side and a right front portion at the connection between the right side and the front side, and the single front sensor is positioned near the left front portion in the case of right-hand driving or near the right front portion in the case of left-hand driving;
the single front sensor is positioned on the roof;
an unobstructed horizontal field of view of the single front sensor covers an angle greater than or equal to 180°, preferably an angle of at least 270°;
it further comprises, for a second given exteroceptive sensor model which is identical to or different from the first sensor model, a single sensor of this second model positioned on a rear portion of the vehicle in order to obtain information about the environment in which the vehicle is located, referred to as a single rear sensor, said single rear sensor being offset from the mid-sagittal plane separating the left portion from the right portion of the vehicle;
in the case of right-hand driving the single rear sensor is offset to the right and in the case of left-hand driving said rear sensor is offset to the left, from the mid-sagittal plane separating the left portion from the right portion of the vehicle;
the single front sensor is positioned on the front portion of the vehicle at a first height, and the single rear sensor is positioned on the rear portion of the vehicle at a second height, the first height and the second height differing from each other by at most 20% of the height of the vehicle;
the single rear sensor is positioned on the roof;
the single front sensor is a LIDAR sensor, a camera, or a radar.

### BRIEF DESCRIPTION OF DRAWINGS

Other aspects, aims, advantages and characteristics of the invention will become better apparent upon reading the following detailed description of some preferred embodiments thereof, given by way of non-limiting example and made with reference to the appended drawings which consider right-hand driving for the example, and in which:

FIGS. 1A and 1B illustrate, for a single front exteroceptive sensor positioned on a vehicle according to the invention, the gain in unobstructed area in the field of view when said vehicle is behind another vehicle partially obstructing its field of view, compared to the same exteroceptive sensor positioned in the mid-sagittal plane of the vehicle;

FIGS. 2A and 2B illustrate the gain in detection distance when the single front exteroceptive sensor is offset laterally from the mid-sagittal plane in accordance with the invention, compared to the case where the single front exteroceptive sensor is positioned at this mid-sagittal plane of the vehicle;

FIGS. 3A and 3B respectively show a side view and a top cross-section view at a height of 1m20 in the field of view of the single front exteroceptive sensor when positioned in the center at the front of the vehicle;

FIGS. 3A and 3B show how the field of view of the single front exteroceptive sensor positioned in the mid-sagittal plane does not allow detecting a child close to the vehicle where the risk is the highest, respectively through the side view and top cross-section view at a height of 1m20.

FIG. 3C shows, through a top cross-section view at a height of 1m20, how this time the child is within the field of view of the single front exteroceptive sensor when the sensor is offset laterally according to the invention;

FIG. 4A shows, in an intersection at an acute angle, the fields of view of the single front exteroceptive sensor according to whether the sensor is positioned at the front in the mid-sagittal plane of the vehicle, or positioned on the vehicle according to the invention, or positioned on the side face of the vehicle;

FIG. 4B shows the perception limits of a single front exteroceptive sensor, according to whether said sensor is positioned on the mid-sagittal plane of the front face of the vehicle or positioned on the vehicle according to the invention;

FIG. 5A shows an embodiment of the invention in which the single front exteroceptive sensor positioned according to the invention is placed at a high position on the vehicle and therefore can observe beyond a user of the road who is located immediately next to said vehicle;

FIGS. 5B and 5C, by way of example where the positioning of the sensor of FIG. 5A will be illustrated, show situations in the positioning of a vehicle on the road relative to other users of the road, respectively when arriving at an intersection between streets with 1×2 lanes or arriving at a roundabout;

FIG. 6 shows an embodiment of the invention in which the fields of view of the single front exteroceptive sensor and of a single rear exteroceptive sensor each cover an angle of 270° and the union of the two fields of view allows observing the perimeter of the vehicle with a 360° horizontal field of view, providing redundancy at the front right portion and the left rear portion;

FIG. 7 shows, through a vertical section view along the right side of the vehicle, how a single right rear exteroceptive sensor allows observing the side access or loading doors located on the curb side, in an embodiment where the two sensors are for example scanning LiDARs;

FIG. 8 shows the lateral distance covered in a turn by the center of the front axle of a vehicle with two steered wheels in comparison with the lateral distance covered by the center of the rear axle, in order to illustrate how the side face of a vehicle with two steered wheels is also able to hit a pedestrian, similarly to the front;

FIGS. 9A and 9B compare the field of view of the single right rear exteroceptive sensor, to the field of view that it would have if it were placed near the right front edge, so as to visualize the blind spot associated with each of said positions. FIG. 9A is a vertical cross-section, and FIG. 9B is a cross-section in the horizontal plane.

In all of these figures, right-hand driving is considered. The placement of the single front sensor of a given model, and where applicable that of the single rear sensor of a given model which is identical to or different from that of the single front sensor, are laterally reversed for left-hand driving.

### DETAILED DESCRIPTION

The invention relates to a vehicle for transporting goods and/or people. The vehicle typically comprises a left side, a right side, a front side which connects the left side and the right side, and a rear side which connects the left side and the right side. A mid-sagittal plane of the vehicle (vertical plane extending from the rear to the front of the vehicle at the middle) separates a left portion from a right portion of the vehicle.

One and/or the other of these sides may be contoured, the invention not being in any way limited to a brick-shaped vehicle but on the contrary extending to any type of shape, including with protrusions capable of carrying sensors. The edges or connections joining the sides may be more or less pronounced, taking the form of broken or continuous lines.

The vehicle may further comprise a roof which has a left front portion at the connection between the left side and the front side and a right front portion at the connection between the right side and the front side, a left rear portion at the connection between the left side and the rear side and a right rear portion at the connection between the right side and the rear side.

The vehicle may be a vehicle with driving assistance (ADAS) or an autonomous vehicle. It is, for example, a vehicle with an electric motor.

According to a first embodiment, the vehicle according to the invention comprises, for a given exteroceptive sensor model, a single instance of this sensor on a front portion of the vehicle in order to obtain information about the environment in which the vehicle is located. For readability, “single front sensor” will be understood below to mean a single instance of a given model positioned on the front portion of the vehicle, with the knowledge that other sensor models, including exteroceptive, may coexist on this portion. If, according to enforced regulations, the vehicle is to travel on a traffic lane intended for right-hand driving, the single front exteroceptive sensor is positioned on the front portion of the vehicle, being offset to the left of the mid-sagittal plane. Conversely, if, according to enforced regulations, the vehicle is to travel on a traffic lane intended for left-hand driving, the single front exteroceptive sensor is positioned on the front portion of the vehicle, being offset to the right of the mid-sagittal plane. Regardless of the direction of traffic that is in force in the vehicle's environment, the single front sensor is therefore located on the side opposite the direction of traffic.

The single front sensor may be positioned on the front of the vehicle anywhere from the grille to the roof, including the side of the hood and windshield. In one embodiment, the single front sensor is carried by an arm secured to the vehicle.

The single front exteroceptive sensor is, for example but not limited to, a LiDAR, a scanning LiDAR, a camera, a hypergon camera, a catadioptric camera, a radar, or a housing which comprises several LiDARs, cameras, or radars.

The information about the environment in which the vehicle is located, delivered by the single front sensor, may be used for example for obstacle detection, localization (relative and/or absolute), and/or mapping.

The invention does not exclude the presence on the front portion of the vehicle of other sensors which do not constitute instances of said exteroceptive sensor model. For example, in addition to said single front sensor, there may be a LIDAR at the bottom center of the front face and two different LiDARs occupying the two front corners, all for obstacle detection but with differences in their detection capabilities.

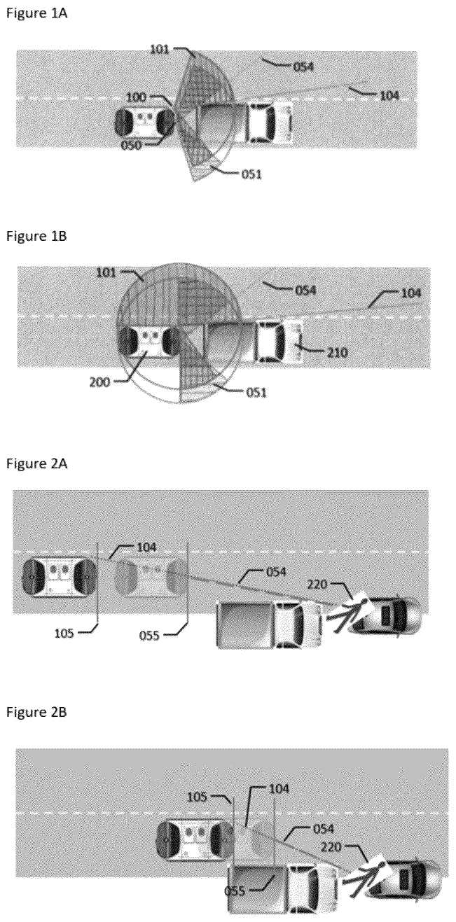

FIGS. 1A and 1B show a common situation of a vehicle 200 located on a road, in an urban environment or some other type of environment, where a second vehicle 210 of similar or even larger size is temporarily in front of said vehicle. Vehicle 200 has a single front instance of a given exteroceptive sensor model, offset to the left of the mid-sagittal plane. Vehicle 200 is traveling on the right.

In particular, FIG. 1A illustrates with vertical stripes 101 the portion of the field of view of sensor 100 of vehicle 200 which is not obstructed by vehicle 210 in the case where the single front exteroceptive sensor is a sensor with a field of less than 180°, offset significantly to the left, the gain being proportional to the offset. For comparison, horizontal stripes 051 show the portion of the field of view not obstructed when a sensor 050 of the same model is placed at the front of vehicle 200 in the mid-sagittal plane. Analogously, FIG. 1B illustrates this for a sensor model covering a field of view greater than 180°, here at least 270°. The portion of field of view 051 not obstructed for the sensor in the central position of the front face of vehicle 200 is indicated by horizontal hatching, while that of the sensor in the lateral position by vertical hatching.

According to one particular embodiment of the invention, the total horizontal field of view of the single front sensor covers an angle greater than or equal to 180°, preferably an angle of 270°. The single front sensor is for example a scanning LiDAR.

Whatever sensor on use with a sufficient field of view, the leftward offset of the front exteroceptive sensor for vehicle 200 allows, with a slight loss at the right front, a gain in the unobstructed field of view towards the front on the left at an angle delimited by lines 054 and 104, as well as a gain in the unobstructed field of view on the other traffic lane (zone 101). In fact, fewer rays are blocked when the sensor is offset laterally.

Thus, when the sensor is used for localization, offsetting the sensor laterally will advantageously allow more rays not to be blocked by the vehicle in front. In addition, offsetting it to the left in the case of right-hand driving will advantageously allow a better view of what is beyond the vehicle in front and in the left lane.

As illustrated in FIG. 1B, the positioning of the single front exteroceptive sensor near the edge between the front face and the left side of vehicle 200 is particularly advantageous in the case of a sensor with a large horizontal field of view, for example a sensor in which the field of view is greater than 180° such as a scanning LiDAR. In effect, such a positioning of the sensor allows making use of the rearward-oriented portion of the FOV of said sensor. When such a sensor is not placed near the edge between the front face and the left side, the rearward-oriented rays of the FOV remain partially unusable if the sensor is placed at roof level and entirely unusable otherwise, due to these rays hitting the vehicle body. By advantageously placing this sensor in the corner, the rearward-oriented rays are no longer blocked. This is also valid for sensors with a horizontal field of view less than 180° but oriented with a non-zero angle relative to the longitudinal axis of the vehicle in such a way that part of their FOV can look rearward.

This thus makes it possible to increase the amount of relevant information in a context of being used for localization, by increasing its coverage spatially.

This is also an answer to the search for minimizing the risk of too much of the sensor's field of view being occupied by a mobile or temporarily static obstacle, which may then be wrongly considered by the algorithms as an integral part of the static reference environment. This is the reason why, for example, ultra-wide-angle cameras are generally preferred in visual SLAM localization applications.

Another possibility to avoid blocking part of the rays would be to raise the sensor well above the roof. However, the choice of such an alternative has the effect of increasing the total height of the vehicle, which is not desirable because of height limits (height restrictors in car parks, limits on transport in containers), loss of aerodynamics, etc.

FIGS. 2A and 2B show another common situation in cases of urban and peri-urban driving, in which a pedestrian 220 is coming out from behind a vehicle parked on the side, the field of view of the sensor being limited along line 054 by the parked vehicle. It is apparent from FIGS. 2A and 2B that the vehicle according to the invention is able to detect pedestrian 220 when the pedestrian crosses line 105. For comparison, a vehicle in which the sensor is at the mid-sagittal axis would only detect the pedestrian starting at line 055. The detection distance is therefore increased. Gaining several precious hundreds of milliseconds by anticipating his or her detection by a few meters allows reducing the number of accidents and limiting their severity. This is advantageously offered by the leftward offset of the single front exteroceptive sensor of vehicle 200.

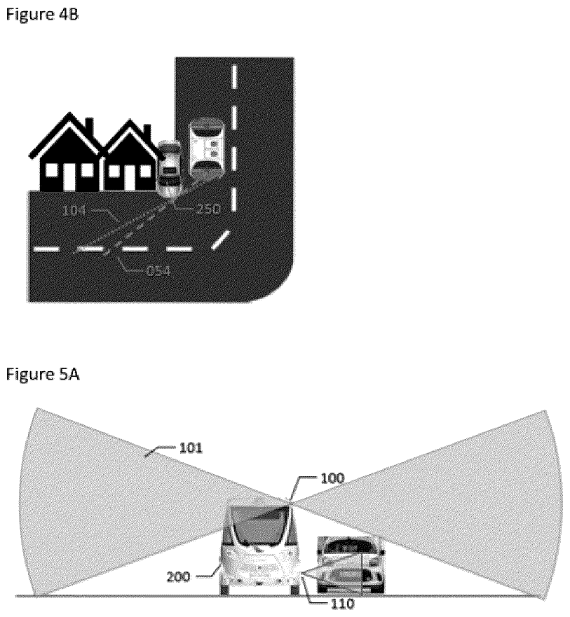

FIGS. 4A and 4B illustrate yet another situation in which the vehicle according to the invention offers a particular advantage. This concerns intersection monitoring. It is not uncommon for a town map not to follow a checkerboard layout. The intersections are therefore not all at right angles, forcing the driver to look over their left shoulder to see what is happening there beyond 90° or to use their side-view mirror. This is also the case for acceleration/insertion lanes.

These kinds of sharp angle intersections are much rarer on the right side. Indeed, as the presence of a passenger to the right, or even the vehicle pillars, then obstruct the driver's view of the intersection, infrastructures generally allow orienting the vehicle over the last few meters so as to be returned to the case of a right-angle intersection.

FIG. 4A therefore shows a scenario with an acute angle intersection, where it is obvious that the horizontally striped field of view 050 of the sensor placed at the mid-sagittal plane at the front of the vehicle cannot observe vehicles arriving from the left. When the sensor is placed near the left front edge, it can then observe horizontally over 270° as illustrated by field of view 101 in which the vertical stripes illustrate the portion of the field that observes said intersection. In the event of the intersection being partially obstructed due to the presence of an obstacle 240, this placement allows maintaining a much better observation of the intersection, limited above dotted line 104, than a sensor set back on the left side, its portion of field of view 150 which observes the intersection then being limited above dashed line 154.

Analogously, FIG. 4B indicates the perception boundaries with dotted lines 104 and dashed lines 054, for when the sensor is placed in the center and is offset significantly to the left of the vehicle respectively, when a vehicle 250 or any other element is impacting visibility in the intersection.

For best observation of the type of intersections illustrated in FIGS. 4A and 4B, it is again particularly advantageous to place the sensor near the left front edge of the vehicle in order to allow rearward observation if its FOV so allows. This eliminates the need to add an additional sensor in order to observe this side. Finally, this also makes it possible to better observe the intersections than a sensor set back on the left side, because then visibility is improved under conditions where buildings, plants, or even a poorly parked vehicle at the intersection partly hide the view.

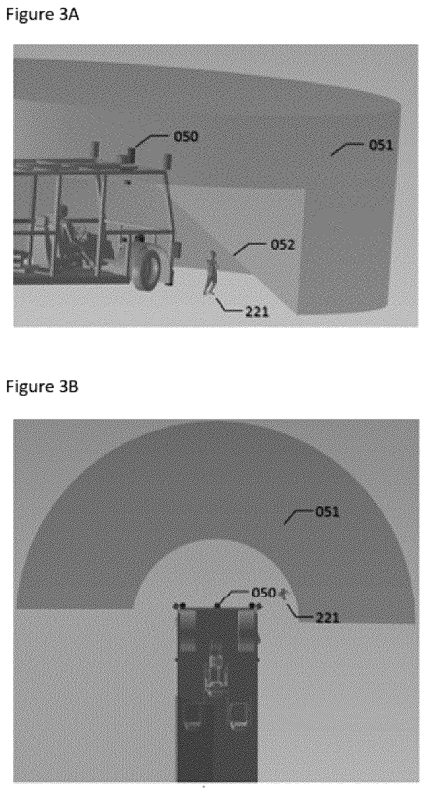

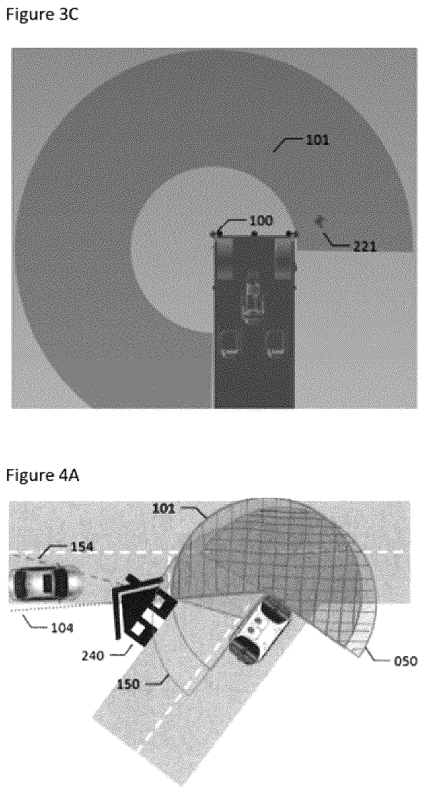

Another element to consider is that it is important in an urban environment to have good coverage of the right front of the vehicle in terms of perception, because this part of vehicles is the first involved in accidents with vulnerable users of the road due to the presence on the right of cycle lanes and sidewalks. Furthermore, it is primarily the right turns which are the tightest, left turns being wider when it comes to making a turn at an intersection with a two-way road having 2×1 lanes. However, considering a young child of small size and a scanning LiDAR type of sensor placed relatively high, given the cone-shaped field of view, offsetting the sensor one meter to the left of center advantageously makes it possible to cover an area one meter closer to the vehicle, thus ensuring that the child is detected as illustrated in FIG. 3.

FIGS. 3A, 3B and 3C thus illustrate the advantage of offsetting a sensor such as a LIDAR to the front left corner in order to have better coverage of the zone close to the vehicle. More specifically, FIG. 3A shows a side view with sensor 050 centered laterally, where the lowest LiDAR beams 052 of field of view 051 pass above the head of child 221; FIG. 3B shows a top view in a horizontal cross-section displaying only elements below a height of 1.20 m, including the cross-section of field of view 051; and FIG. 3C shows this same view but with the same LiDAR 100 offset towards the front left corner where one can see that child 221 is now within field of view 101 of the sensor.

In one particular embodiment of the vehicle according to the invention, the sensor is positioned on the front portion of the vehicle at the connection between the left side and the front side in the case of right-hand driving or at the connection between the right side and the front side in the case of left-hand driving. Without this being limiting, the single front sensor is for example positioned in an upper part of the front portion of the vehicle. It may in particular be positioned near the left front portion of the roof in the case of right-hand driving or near the right front portion of the roof in the case of left-hand driving. It may be positioned on the roof or on an upper portion of the front side.

Positioning the sensor at height, or even on the roof, is a particularly advantageous embodiment for having perception beyond a user of the road who could obstruct a large portion of the field of view of a sensor placed lower down, due to the user's close proximity to the vehicle. In addition, because of its high position at the left front portion of the roof, the sensor is more likely to be able to observe 270° of the scene.

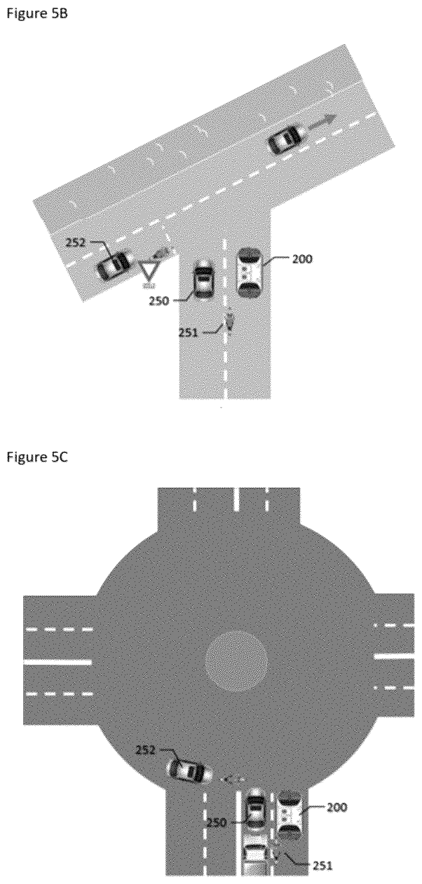

FIGS. 5A, 5B and 5C illustrate situations where positioning the sensor up high may be particularly advantageous, such as when stopping at traffic lights on 2×2 lane streets (not shown here) or when arriving at a roundabout intersection. In FIGS. 5A, 5B and 5C, single front sensor 100 is positioned up high on vehicle 200 so that it is less subject to a partial obstruction of field of view 101 due to other users of the road (such as cars 250 and motorcycles 251) than a sensor 110 located in a low position. In addition, when placed at the left front portion, single front sensor 100 may thus more easily observe 270° of the scene, allowing it to better negotiate the intersection of FIG. 5B or the roundabout intersection of FIG. 5C due to the perception of vehicles 252 arriving from its left.

According to another embodiment, the vehicle according to the invention comprises, in addition to the single front sensor of a first given model, a single rear exteroceptive sensor for obtaining information about the environment where the vehicle is located. For readability, “single rear sensor” is understood here to mean a single instance of a second given exteroceptive sensor model for the rear portion of the vehicle, this second given model able to be identical to or different from that of the single front sensor, several sensor models being able to coexist on a same portion of the vehicle. For example, the single front sensor is an instance of a first LiDAR model and the single rear sensor is an instance of a second LiDAR model that is different from the first model. In another example, the single front sensor is an instance of a scanning LiDAR model and the single rear sensor is an instance of a camera model with a horizontal FOV of 360°.

In the case where the vehicle is driving on the right, the single rear sensor is offset to the right of the mid-sagittal plane. If the vehicle is driving on the left, the single rear exteroceptive sensor is positioned to be offset to the left of the mid-sagittal plane. Arrangements similar to those described above for the single front sensor (for example at height or not, on the roof or not) may be used for the single rear sensor.

Thus, the single rear sensor and the single front sensor are not located on the same side:
if the single front sensor is offset to the left, the single rear sensor is offset to the right,
respectively, if the single front sensor is offset to the right, the single rear sensor is offset to the left.

As explained above for the state of the art, when localization is concerned, the choice is generally made to place two sensors in the mid-sagittal plane at the front and rear of the vehicle, thus making it possible to increase the precision in evaluating the vehicle's heading. As was explained above for the case of a single sensor, it is also not optimal to leave the rear sensor in the center.

An offset to the left in relation to the vehicle's longitudinal axis, i.e. to the same side as the front sensor, may be recommended if we want to observe the vehicles that may overtake us. However, several other reasons lead us to favor an offset to the right instead.

Thus, an offset to the right will further increase the distance between the sensors, further increasing precision in the heading.

Having the rear sensor diametrically opposed to the one at the front is also a desired aspect to avoid having the two sensors, if they are primarily used for localization purposes, disrupted simultaneously by the arrival of a vehicle to the left side of our vehicle, especially if this other vehicle is large.

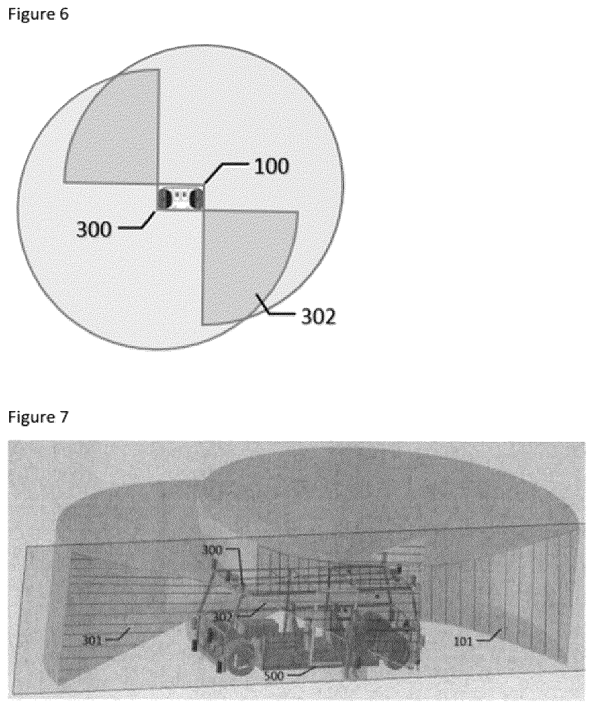

Furthermore, FIG. 6 shows how the positioning of single rear sensor 300, by supplementing the positioning of single front sensor 100, allows observing the periphery of the vehicle with a 360° horizontal field of view, with redundancy at right front portion 302 which is the most sensitive regarding vulnerable users of urban space. We will also have redundancy at the left rear area where vehicles preparing to overtake us would be located.

Thus, in the case where the two sensors are each capable of covering a horizontal field close to 270° for example, placing the second sensor at the right rear edge advantageously allows the two to cover the 360° around the vehicle, the second having responsibility for the rear and right sides of the vehicle.

Furthermore, in the case of public transportation vehicles and freight vehicles, these open to the right, on the sidewalk side (if the latter is not rear-loading). This second sensor is therefore advantageously placed at a right corner of the vehicle in order to monitor side accesses.

Thus, FIG. 7 shows a vertical cross-section view along the right side of the vehicle, for one embodiment, of the vertically striped field of view 101 of a left front scanning LiDAR and of the horizontally striped field of view 301 of a right rear scanning LiDAR 300, in particular with the lower periphery of this field indicated by a light line 302 thus illustrating to what extent the field of view of this sensor is covering side access door 500 of the vehicle.

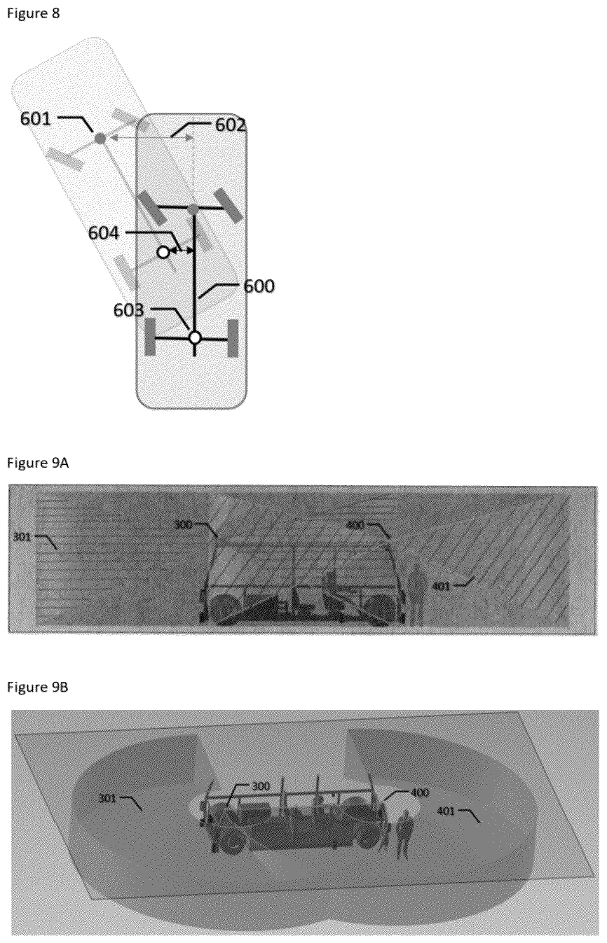

Finally, it remains important to monitor the front of the right side of the vehicle because, firstly, this is the side where vulnerable users of the road are found in the majority of cases, and secondly, with vehicles with two steered wheels, the rear axle does not exactly follow the path of the front axle when cornering but cuts across this path. This being so, when turning, the lateral sides of the vehicle have a movement component in the horizontal plane that is normal to the axis of the vehicle, a component which is all the more significant as t is observed towards the front of the vehicle and as the turn is tigh. FIG. 8 illustrates this with lateral distance 602 traveled by the center of front axle 601 of a vehicle with two steered wheels 600 in a turn in comparison to lateral distance 604 traveled by the center of rear axle 603. In other words, the lateral side of the vehicle may hit a pedestrian, a cyclist, or any other user of the road, with an impact that grows harder the closer it is to the front end of the vehicle. However, if the second sensor is installed at height for a primary requirement of localization, with the majority of sensors having a limited vertical FOV, the most dangerous lateral zone may not be in its FOV if the sensor is located above this front zone. FIG. 9 illustrates the blind spot in the danger zone for pedestrians, cyclists and other vulnerable users of the road, below the diagonally striped field of view 401 of a sensor placed at the right front 400 in comparison to that of a sensor 300 placed at the right rear. This illustration is shown in FIG. 9A in a vertical cross-section, and in a cross-section in the horizontal plane in FIG. 9B. Note that, for display reasons, the length associated with the fields of view stops with the first ray coming into contact with the ground. In practice, the rays that do not encounter obstacles naturally extend beyond this distance. The sensor is therefore here again advantageously placed near the right rear edge in order to be able to monitor this area.

There remains therefore the comparison with the option commonly observed in non-bidirectional vehicles, namely two sensors placed one on either side of the front structure of the vehicle. This positioning makes it possible first of all to ensure perception redundancy in front of the vehicle in the event that one of the sensors fails, whether mechanically, electrically, electronically, in its data analysis software for deriving high-level information, or even due to environmental conditions leading to perception artifacts. However, as is taking place in aeronautics with engines, sensors as a system are becoming more reliable, both as relates to hardware issues and to the intelligence of the algorithms which use their data. This being so, most of the need for redundancy is disappearing.

And with usable vertical fields of view that are increasingly large, it is becoming technically possible to lower the minimum distance that allows observing the vertical dimension of the apparent obstacle, and thus to improve recognition of a drop of water from an actual obstacle. The contributions from sensors positioned to observe each other will therefore diminish.

Thus, at the end, when the choice is made to use two sensors, the main advantages which justify placing the sensors at the front left and right corners will disappear. And comparative analysis of the contributions of each of the configurations will lead to the conclusion that the placement of this second sensor at the right rear edge will allow meeting the greatest number of requirements.

1-11. (canceled)

12. A vehicle for transporting goods and/or people in a traffic lane intended for right-hand driving or left-hand driving, comprising, for a first given exteroceptive sensor model, a single sensor of this first model positioned on a front portion of the vehicle in order to obtain information about the environment in which the vehicle is located, referred to as single front sensor, wherein, in the case of right-hand driving the single front sensor is offset to the left and in the case of left-hand driving said front sensor is offset to the right, from a mid-sagittal plane separating a left portion from a right portion of the vehicle.

13. The vehicle according to claim 12, comprising a left side, a right side, a front side which connects the left side and the right side, and wherein the single front sensor is positioned on the front portion of the vehicle at the connection between the left side and the front side in the case of right-hand driving or at the connection between the right side and the front side in the case of left-hand driving.

14. The vehicle according to claim 12, wherein the single front sensor is positioned in an upper part of the front portion of the vehicle.

15. The vehicle according to claim 14, comprising a roof which has a front left portion at the connection between the left side and the front side and a front right portion at the connection between the right side and the front side, and wherein the single front sensor is positioned near the front left portion in the case of right-hand driving or near the front right portion in the case of left-hand driving.

16. The vehicle according to claim 15, wherein the single front sensor is positioned on the roof.

17. The vehicle according to claim 12, wherein an unobstructed horizontal field of view of the single front sensor covers an angle greater than or equal to 180°, preferably an angle of at least 270°.

18. The vehicle according to claim 12, further comprising, for a second given exteroceptive sensor model which is identical to or different from the first sensor model, a single sensor of this second model positioned on a rear portion of the vehicle in order to obtain information about the environment in which the vehicle is located, referred to as a single rear sensor, said single rear sensor being offset from the mid-sagittal plane separating the left portion from the right portion of the vehicle.

19. The vehicle according to claim 18, wherein, in the case of right-hand driving the single rear sensor is offset to the right and in the case of left-hand driving said rear sensor is offset to the left, from the mid-sagittal plane separating the left portion from the right portion of the vehicle.

20. The vehicle according to claim 18, wherein the single front sensor is positioned on the front portion of the vehicle at a first height, the single rear sensor is positioned on the rear portion of the vehicle at a second height, the first height and the second height differing from each other by at most 20% of the height of the vehicle.

21. The vehicle according to claim 18, wherein the single rear sensor is positioned on the roof.

22. The vehicle according to claim 12, wherein the single front sensor is a LiDAR sensor, a camera, or a radar.
